(19) United States
(12) Patent Application Publication
(10) Pub. No.: US 2005/0018191 A1
(43) Pub. Date: Jan. 27, 2005

(54) Apparatus and method for measuring colour

(76) Inventors: Ming Ronnier Luo, Leicestershire (GB); Chuangjun Li, Derby (GB); Guihua Cui, Derby (GB)

Correspondence Address: SMITH-HILL AND BEDELL, 12670 N W BARNES ROAD, SUITE 104, PORTLAND, OR, 97229, US

(21) Appl. No.: 10/491,706

(22) PCT Filed: Oct. 4, 2002
(86) PCT No.: PCT/GB02/04521

(30) Foreign Application Priority Data
Oct. 4, 2001 (GB) 0123810.4
Oct. 15, 2001 (GB) 0124683.4

(51) Int. Cl. G01J 3/40

(52) U.S. Cl. 356/404

(57) ABSTRACT

An apparatus and method for measuring colours of an object includes an enclosure for receiving the object; illumination means for illuminating the object within the enclosure; a digital camera for capturing an image of the object; a computer connected to the digital camera, for processing information relating to the image of the object; and display means for displaying information relating to the image of the object. The enclosure may include means for mounting an object therein such that its position may be altered. These means may include a tiltable table for receiving the object, the tiltable table being controllable by the computer. the illumination means are preferably located within the enclosure, and may include diffusing means for providing a diffuse light throughout the enclosure. the illumination means may include a plurality of different light sources for providing respectively different illuminations for the object, one or more of the light sources may be adjustable to adjust the level of the illumination or the direction of the illumination. The light sources may be controllable by the computer.

The present invention relates to an apparatus and method for measuring colours, using a digital camera.

There are many applications in which the accurate measurement of colour is very important. Firstly, in the surface colour industries such as textiles, leather, paint, plastics, packaging, printing, paper and food, colour physics systems are widely used for colour quality control and recipe formulation purposes. These systems generally include a computer and a colour measuring instrument, typically a spectrophotometer, which defines and measures colour in terms of its calorimetric values and spectral reflectance. However, spectrophotometers are expensive and can only measure one colour at a time. In addition, spectrophotometers are unable to measure the colours of curved surfaces or of very small areas.

A second area in which accurate colour characterisation is very important is in the field of graphic arts, where an original image must be reproduced on to a hard copy via a printing process. Presently, colour management systems are frequently used for predicting the amounts of inks required to match the colours of the original image. These systems require the measurement of a number of printed colour patches on a particular paper media via a colour measurement instrument, this process being called printer characterisation. As mentioned above, the colour measuring instruments can only measure one colour at a time.

Finally, the accurate measurement of colour is very important in the area of professional photography, for example for mail order catalogues, internet shopping, etc. There is a need to quickly capture images with high colour fidelity and high image quality over time.

The invention relates to the use of an apparatus including a digital camera for measuring colour. A digital camera represents the colour of an object at each pixel within an image of the object in terms of red (R), green (G) and blue (B) signals, which may be expressed as follows:

$$\begin{matrix}\begin{matrix}R = {k}^{′} {\int }_{a}^{b} S ( λ ) \overline{r} ( λ ) R ( λ ) ⅆ λ \\ G = {k}^{′} {\int }_{a}^{b} S ( λ ) \overline{g} ( λ ) R ( λ ) ⅆ λ\end{matrix} \\ B = {k}^{′} {\int }_{a}^{b} S ( λ ) \overline{b} ( λ ) R ( λ ) ⅆ λ\end{matrix}$$

where S(λ) is the spectral power distribution of the illuminant, R(λ) is the reflectance function of a physical object captured by a camera at a pixel within the image (and is between 0 and 1) and \overline{r}, \overline{g}, \overline{b} are the responses of the CCD sensors used by the camera. All the above functions are defined within the visible range, typically between a=400 and b=700 nm. The k′ factor is a normalising factor to make G equal to 100 for a reference white.

The colour of the object at each pixel may alternatively be expressed in terms of standard tristimulus (X, Y, Z) values, as defined by the CIE (International Commission on Illumination). The tristimulus values are defined as follows:

$$\begin{matrix}\begin{matrix}X = k {\int }_{b}^{b} S ( λ ) \overline{x} ( λ ) R ( λ ) ⅆ λ \\ Y = k {\int }_{b}^{b} S ( λ ) \overline{y} ( λ ) R ( λ ) ⅆ λ\end{matrix} \\ Z = k {\int }_{b}^{b} S ( λ ) \overline{z} ( λ ) R ( λ ) ⅆ λ\end{matrix}$$

where all the other functions were defined. The \overline{x,y,z} are the CIE 1931 or 1964 standard colorimetric observer functions, also known as colour matching functions (CMF), which define the amounts of reference red, green and blue lights in order to match a monochromatic light in the visible range. The k factor is a normalising factor to make Y equal to 100 for a reference white.

In order to provide full colour information about the object, it is desirable to predict the calorimetric values or reflectance function of the object at each pixel, from the RGB or X, Y, Z values. The reflectance function defines the extent to which light at each visible wavelength is reflected by the object and therefore provides an accurate characterisation of the colour. However, any particular set of R, G, B or X, Y, Z values could define any of a large number of different reflectance functions. The corresponding colours of these reflectance functions will produce the same colour under a reference light source, such as daylight. However, if an inappropriate reflectance function is derived from the camera R, G, B values, the colour of the object at the pixel in question may be defined in such a way that, for example, it appears to be a very different colour under a different light source, for example a tungsten light.

The apparatus according to a preferred embodiment of the invention allows:
the colour of an object at a pixel or group of pixels to be measured in terms of tristimulus values;
the colour of an object at a pixel or group of pixels to be measured in terms of reflectance values via spectral sensitivities of a camera (from the RGB equations above);
the colour of an object at a pixel or group of pixels to be measured in terms of reflectance values via standard colour matching functions (from the X, Y, Z equations above).

According to the invention there is provided an apparatus for measuring colours of an object, the apparatus including:
an enclosure for receiving the object;
illumination means for illuminating the object within the enclosure;
a digital camera for capturing an image of the object;
a computer connected to the digital camera, for processing information relating to the image of the object; and
display means for displaying information relating to the image of the object.

Where the term “digital camera” is used, it should be taken to be interchangeable with or to include other digital imaging means such as a colour scanner.

The enclosure may include means for mounting an object therein such that its position may be altered. These means may include a tiltable table for receiving the object. Preferably the tiltable table is controllable by the computer.

Preferably the illumination means are located within the enclosure. The illumination means may include diffusing means for providing a diffuse light throughout the enclosure. Preferably the illumination means includes a plurality of different light sources for providing respectively different illuminations for the object. One or more of the light sources may be adjustable to adjust the level of the illumination or the direction of the illumination. The light sources may be controllable by the computer.

Preferably the digital camera is mounted on the enclosure and is directed into the enclosure for taking an image of the object within the enclosure. Preferably the camera is mounted such that its position relative to the enclosure may be varied. Preferably the location and/or the angle of the digital camera may be varied. The camera may be adjusted by the computer.

The display means may include a video display unit, which may include a cathode ray tube (CRT).

According to the invention there is further provided a method for measuring colours of an object, the method including the steps of:
locating the object in an enclosure;
illuminating the object within the enclosure;
using a digital camera to capture an image of the object within the enclosure;
using a computer to process information relating to the image of the object; and
displaying selected information relating to the image of the object.

The method may include the step of illuminating the object with a number of respectively different light sources. The light may be diffuse. The light sources may be controlled by the computer.

The digital camera may also be controlled by the computer.

The method preferably includes the step of calibrating the digital camera, to transform its red, green, blue (R, G, B) signals into standard X, Y, Z values. The calibration step may include taking an image of a reference chart under one or more of the light sources and comparing the camera responses for each known colour within the reference chart with the standard X, Y, Z responses for that colour.

For each pixel, the relationship between the measured R, G, B values and the predicted X, Y, Z values is preferably represented as follows:

$$[ \begin{matrix}{X}_{p} \\ {Y}_{p} \\ {Z}_{p}\end{matrix} ] = [ \begin{matrix}{a}_{1 , 1} & {a}_{1 , 2} & … & {a}_{1 , 11} \\ {a}_{2 , 1} & {a}_{2 , 2} & … & {a}_{2 , 11} \\ {a}_{3 , 1} & {a}_{3 , 2} & … & {a}_{3 , 11}\end{matrix} ] [ \begin{matrix}R \\ G \\ B \\ {R}^{2} \\ {G}^{2} \\ {B}^{2} \\ RG \\ GB \\ BR \\ RGB \\ 1\end{matrix} ]$$

which can be expressed in the matrix form: X=MR, and hence M=XR⁻¹

The coefficients in the 3 by 11 matrix M are preferably obtained via an optimisation method based on the least square technique, the measure used (Error) being as follows, where n=240 colours in a calibration chart:

$$Error = {\sum }_{i = 1}^{n} [ {( {X}_{M} - {X}_{P} )}^{3} + {( {Y}_{M} - {Y}_{P} )}^{2} + {( {Z}_{M} - {Z}_{P} )}^{2} ]$$

where X_{M}, Y_{M}, Z_{M} are the measured tristimulus values and Xₚ, Zₚ, Zₚ are the predicted tristimulus values.

The method may include the step of predicting a reflectance function for a pixel or group of pixels within the image of the object. The method may include the following steps:
uniformly sampling the visible range of wavelengths (λ=a to λ=b) by choosing an integer n and specifying that
λᵢ=a+(i−1)Δλ, i=1, 2, . . . n, with

$$Δλ = \frac{b - a}{n - 1} ;$$
defining a relationship between camera output and reflectance function, using the following equation: P=W^{T}r,
where P includes known Xₚ, Yₚ, Zₚ values, W is a known weight matrix derived from the product of an illuminant function and the CIE \overline{x}, \overline{y}, \overline{z} colour matching functions, W^{T} is the transposition of the matrix W and r is an unknown n component column vector representing reflectance function defined by:

$$r = [ \begin{matrix}R ( {λ}_{1} ) \\ R ( {λ}_{2} ) \\ ⋮ \\ R ( {λ}_{n} )\end{matrix} ]$$

where R(λ₁) to R(λₙ) are the unknown reflectances of the observed object at each of the n different wavelengths; and
finding a solution for P=W^{T}r which includes a measure of both the smoothness and the colour constancy of the reflectance function, the relative importance of smoothness and of colour constancy being defined by respective weighting factors.

Using the above method, the camera is initially calibrated so that measured R, G, B values can be transformed to predicted Xₚ, Yₚ, Zₚ values. The Xₚ, Yₚ, Zₚ values may then be used to predict the reflectance functions.

Alternatively the R, G, B values may be used to predict reflectance functions directly using the following steps:
uniformly sampling the visible range of wavelengths (λ=a to λ=b) by choosing an integer n and specifying that
λᵢ=a+(i−1)Δλ, i=1,2, . . . n, with

$$Δλ = \frac{b - a}{n - 1} ;$$
defining a relationship between camera output and reflectance function, using the following equation: P=W^{T}r,
where P includes known camera R, G, B values, W is a known weight matrix derived from the product of an illuminant function and the CIE \overline{x}, \overline{y}, \overline{z} colour matching functions, W^{T} is the transposition of the matrix W and r is an unknown n component column vector representing reflectance function defined by:

$$r = [ \begin{matrix}R ( {λ}_{1} ) \\ R ( {λ}_{2} ) \\ ⋮ \\ R ( {λ}_{n} )\end{matrix} ]$$

where R(λ₁) to R(λₙ) are the unknown reflectances of the observed object at each of the n different wavelengths; and
finding a solution for P=W^{T}r which includes a measure of both the smoothness and the colour constancy of the reflectance function, the relative importance of smoothness and of colour constancy being defined by respective weighting factors.

The weighting factors may be predetermined and are preferably calculated empirically.

Preferably n is at least 10. Most preferably n is at least 16, and n may be 31.

Preferably the smoothness is defined by determining the following:

$$\frac{Min}{r} ‖ Gr ‖ 2$$

where G is an (n−1)×(n) matrix defined by the following:

$$G [ \begin{matrix}- \frac{1}{\sqrt{2}} & \frac{1}{\sqrt{2}} & & & & \\ & - 1.0 & 1.0 & & & \\ & & ⋰ & ⋰ & & \\ & & - 1.0 & 1.0 & & \\ & & & & - \frac{1}{\sqrt{2}} & \frac{1}{\sqrt{2}}\end{matrix} ]$$

where r is an unknown n component column vector representing reflectance function (referred to as the “reflectance vector”) and ∥y∥ is the 2-norm of the vector y, defined by

$$‖ y ‖ = \sqrt{{\sum }_{K = 1}^{N} {y}_{k}^{2}}$$

(if y is a vector with N components).

Preferably o≦r≦e where o is an n component zero vector and e is an n component column vector where all the elements are unity (equal one).

Preferably the colour constancy of the reflectance vector is calculated as follows:
compute tristimulus X, Y, Z values (denoted P_{R}) using the reflectance vector, under a reference illuminant;
compute tristimulus X, Y, Z values (denoted P_{T}) using the reflectance vector, under a test illuminant;
using a chromatic adaptation transform, transfer P_{T} to a corresponding colour denoted by P_{TC} under the reference illuminant;
compute the difference ΔE between P_{TC} and P_{R}; and define the colour inconstancy index (CON) as ΔE.

A plurality J of test illuminants may be used such that the colour inconstancy index is defined as

$${\sum }_{j = 1}^{J} {β}_{j} Δ {E}_{j}$$

where βⱼ is a weighting factor defining the importance of colour constancy under a particular illuminant j.

The reference illuminant is preferably D65, which represents daylight;

The preferred method for predicting the reflectance function may thus be defined as follows:
choose a reference illuminant and J test illuminants;
choose a smoothness weighting factor cc and weighting factors βⱼ, j=1, 2, . . . J for CON; and
for a given colour vector P and weight matrix W solve the following constrained non-linear problem:

$$\frac{Min}{r} [ α {‖ G r ‖}^{2} + {\sum }_{j = 1}^{J} {β}_{j} Δ {E}_{j} ]$$

subject to o≦r≦e and P=W^{T}r for the reflectance vector r.

The smoothness weighting function a may be set to zero, such that the reflectance is generated with the least colour inconstancy.

The colour constancy weighting factors βⱼ may alternatively be set to zero, such that the reflectance vector has smoothness only.

Preferably α and βⱼ are set such that the method generates a reflectance function having a high degree of smoothness and colour constancy. The values of α and βⱼ may be determined by trial and error.

Preferably the method further includes the step of providing an indication of an appearance of texture within a selected area of the object. The method may include the steps of:
determining an average colour value for the whole of the selected area; and
determining a difference value at each pixel within the image of the selected area, the difference value representing the difference between the measured colour at that pixel and the average colour value for the selected area.

Preferably the selected area has a substantially uniform colour.

The difference value may be a value ΔY which represents the difference between the tristimulus value Y at that pixel and the average \overline{Y} for the selected area.

Alternatively, the difference value may also include a value ΔX which represents the difference between the tristimulus value X at that pixel and the average \overline{X} for the selected area and/or a value ΔZ which represents the difference between the tristimulus value Z at that pixel and the average \overline{Z} for the selected area.

The texture of the selected area may be represented by an image comprising the difference values for all the respective pixels within the selected area.

The method may further include the step of simulating the texture of a selected area of an object, for example in an alternative, selected colour. The method may include the step of:
obtaining X, Y, Z values for the selected colour;
converting these to x, y, Y values, where:

$$x = \frac{X}{X + Y + Z} , y = \frac{Y}{X + Y + Z} , z = \frac{Z}{X + Y + Z}$$

where
x+y+z=1;
transforming the Y value for each pixel l,m to Y_{l,m}=Y+tΔY_{l,m},
where t is a function of Y.

The x, y, and Y_{l,m} values for each pixel may be converted to X_{l,m}, Y_{l,m}, Z_{l,m} values. The X, Y, Z values may then be transformed to monitor R, G, B values, for displaying the selected colour with the simulated texture on the display means.

Alternatively, the X, Y, Z values for each pixel l,m may be transformed to:
X_{l,m}=X+tₓΔX_{l,m}
Y_{l,m}=Y+t_{y}ΔY_{l,m}
Z_{l,m}=Z+t_{z}ΔZ_{l,m}

An embodiment of the invention will be described for the purpose of illustration only with reference to the accompanying drawings in which:

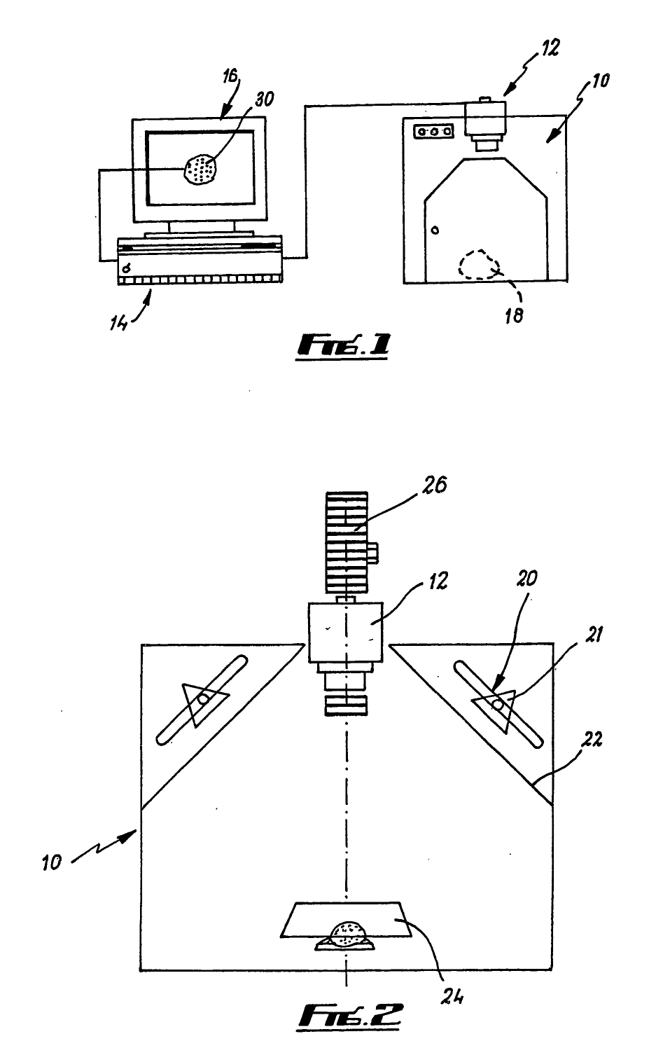

FIG. 1 is a diagrammatic overview of an apparatus according to the invention;

FIG. 2 is a diagrammatic sectional view of an illumination box for use with the apparatus of FIG. 1.

Referring to FIG. 1, an apparatus according to the invention includes an illumination box 10 in which an object 18 to be observed may be placed. A digital camera 12 is located towards the top of the illumination box 10 so that the digital camera 12 may take a picture of the object 18 enclosed in the illumination box 10. The digital camera 12 is connected to a computer 14 provided with a video display unit (VDU) 16, which includes a colour sensor 30.

Referring to FIG. 2, the illumination box 10 is provided with light sources 20 which are able to provide a very carefully controlled illumination within the box 10. Each light source includes a lamp 21 and a diffuser 22, through which the light passes in order to provide uniform, diffuse light within the illumination box 10. The inner surfaces of the illumination box are of a highly diffusive material coated with a matt paint for ensuring that the light within the box is diffused and uniform.

The light sources are able to provide a variety of different illuminations within the illumination box 10, including: D65, which represents daylight; tungsten light; and lights equivalent to those used in various department stores, etc. In each case the illumination is fully characterised, i.e., the amounts of the various different wavelengths of light are known.

The illumination box 10 includes a tiltable table 24 on which the object 18 may be placed. This allows the angle of the object to be adjusted, allowing different parts of the object to be viewed by the camera.

The camera 12 is mounted on a slider 26, which allows the camera to move up and down as viewed in FIG. 2. This allows the lens of the camera to be brought closer to and further away from the object, as desired. The orientation of the camera may also be adjusted.

Referring again to FIG. 1, the light sources 20, the digital camera 12 and its slider 26 and the tiltable table 24 may all be controllable automatically from the computer 14. Alternatively, control may be effected from control buttons on the illumination box or directly by manual manipulation.

The digital camera 12 is connected to the computer 14 which is in turn connected to the VDU 16. The image taken by the camera 12 is processed by the computer 14 and all or selected parts of that image or colours or textures within that image may be displayed on the VDU and analysed in various ways. This is described in more detail hereinafter.

The digital camera describes the colour of the object at each pixel in terms of red (R), green (G) and blue (B) signals, which are expressed in the following equations

$$R = {k}^{′} {\int }_{a}^{b} S ( λ ) \overline{r} ( λ ) R ( λ ) ⅆ λ \\ G = {k}^{′} {\int }_{a}^{b} S ( λ ) \overline{g} ( λ ) R ( λ ) ⅆ λ \\ B = {k}^{′} {\int }_{a}^{b} S ( λ ) \overline{b} ( λ ) R ( λ ) ⅆ λ \qquad Equation 1$$

S(λ) is the spectral power distribution of the illuminant. Given that the object is illuminated within the illumination box 10 by the light sources 20, the spectral power distribution of any illuminant used is known. R(λ) is the reflectance function of the object at the pixel in question (which is unknown) and \overline{r},\overline{g},\overline{b} are the spectral sensitivities of the digital camera, i.e., the responses of the charge coupled device (CCD) sensors used by the camera.

All the above functions are defined within the visible range, typically between a=400 and b=700 nm.

There are known calibration methods for converting a digital camera's R, G, B signals in the above equation into the CIE tristimulus values (X, Y, Z). The tristimulus values are defined in the following equations:

$$X = k {\int }_{b}^{b} S ( λ ) \overline{x} ( λ ) R ( λ ) ⅆ λ \\ Y = k {\int }_{b}^{b} S ( λ ) \overline{y} ( λ ) R ( λ ) ⅆ λ \\ Z = k {\int }_{b}^{b} S ( λ ) \overline{z} ( λ ) R ( λ ) ⅆ λ \qquad Equation 2$$

where all the other functions in equation (1) were defined. The \overline{x,y,z} are the CIE 1931 or 1964 standard calorimetric observer functions, also known as colour matching functions (CMF), which define the amounts of reference red, green and blue lights in order to match a monochromatic light in the visible range. The k factor in equation (2) is a normalising factor to make Y equal to 100 for a reference white.

In order that the R, G, B values captured by the digital camera may be transformed into X, Y, Z values, it is desirable to calibrate the digital camera before the apparatus is used to measure colours of the object 18. This is done each time the camera is switched on or whenever the light source or camera setting is altered. Preferably the camera is calibrated by using a standard colour chart, such as a GretagMacbeth ColorChecker Chart or Digital Chart.

The chart is placed in the illumination box 10 and the camera 12 takes an image of the chart. For each colour in the chart, the X, Y, Z values are known. The values are obtained either from the suppliers of the chart or by measuring the colours in the chart by using a colour measuring instrument. A polynomial modelling technique may be used to transform from the camera R, G, B values to X, Y, Z values. For a captured image from the camera, each pixel represented by R, G, B values is transformed using the following equation to predict Xₚ, Yₚ, Zₚ values, these being the X, Y, Z values at a particular pixel:

$$[ \begin{matrix}{X}_{p} \\ {Y}_{p} \\ {Z}_{p}\end{matrix} ] = [ \begin{matrix}{a}_{1 , 1} & {a}_{1 , 2} & - {a}_{1 , 11} \\ {a}_{2 , 1} & {a}_{2 , 2} & - {a}_{2 , 11} \\ {a}_{3 , 1} & {a}_{3 , 2} & - {a}_{3 , 11}\end{matrix} ] [ \begin{matrix}R \\ G \\ B \\ {R}^{2} \\ {G}^{2} \\ {B}^{2} \\ RG \\ GB \\ BR \\ RGB \\ 1\end{matrix} ]$$

which can be expressed in the matrix form: X=MR, and hence, M=XR⁻¹.

The coefficients in the 3 by 11 matrix M may be obtained via an optimisation method based on a least squares technique. The measure used (Error) is as follows, where n=240 colours in a standard calibration chart:

$$Error = {\sum }_{i = 1}^{n} [ {( {X}_{M} - {X}_{P} )}^{2} + {( {Y}_{M} - {Y}_{P} )}^{2} + {( {Z}_{M} - {Z}_{P} )}^{2} ]$$

where X_{M}, Y_{M}, Z_{M} are the measured tristimulus values and Xₚ, Yₚ, Zₚ are the predicted tristimulus values.

Using the above technique, the digital camera may be calibrated such that its R, G, B readings for any particular colour may be accurately transformed into standard X, Y, Z values.

It is also necessary to characterise the VDU 16. This may be carried out using known techniques, such as are described in Berns R. S. et al, CRT colorimetry, Part I and II at Col, Res Appn, 1993.

Once the camera 12 and VDU 16 have been calibrated, a sample object may be placed into the illumination box 10. The digital camera is controlled directly or via the computer 14, to take an image of the object 18. The image may be displayed on the VDU 16. In analysing and displaying the image, the apparatus preferably predicts the reflectance function of the object at each pixel. This ensures that the colour of the object is realistically characterised and can be displayed accurably on the VDU, and reproduced on other objects if required.

One method of predicting reflectance functions from R, G, B or X, Y, Z values is as follows.

If we uniformly sample the visible range (a, b) by choosing an integer n and
λᵢ=a+(i−1), i=1,2, . . . n with

$$Δ λ = \frac{b - a}{n - 1}$$

then the equations (1) and (2) can be rewritten as the following matrix vector form to define a relationship between camera output and reflectance function:
p=W^{T}r Equation 3

Here, p is a 3-component column vector consisting of the camera response, W is a n×3 matrix called the weight matrix, derived from the illuminant function and the sensors of the camera for equation (1), or from the illuminant used, and the colour matching functions for equation (2), W^{T} is the transposition of the matrix W and r is the unknown n component column vector (the reflectance vector) representing unknown reflectance function given by:

$$r = [ \begin{matrix}R ( {λ}_{1} ) \\ R ( {λ}_{2} ) \\ ⋮ \\ R ( {λ}_{n} )\end{matrix} ] \qquad Equation 4$$

The 3-component column vector p consists of either the camera responses R, G and B for the equation (1), or the CIE tristimulus values X, Y and Z for the equation (2).

Note also that the reflectance function R(λ) should satisfy:
0≦R(λ)≦1

Thus, the reflectance vector r defined by equation (4) should satisfy:
o≦r≦e Equation 5

Here o is a n-component zero vector and e is a n-component vector where all the elements are unity (equal one).

Some fluorescent materials have reflectances of more than 1, but this method is not generally applicable to characterising the colours of such materials.

The preferred method used with the present invention recovers the reflectance vector r satisfying equation (3) by knowing all the other parameters or functions in equations (1) and (2).

The method uses a numerical approach and generates a reflectance vector r defined by equation (4) that is smooth and has a high degree of colour constancy. In the surface industries, it is highly desirable to produce colour constant products, i.e., the colour appearance of the goods will not be changed when viewed under a wide range of light sources such as daylight, store lighting, tungsten.

Firstly, a smoothness constraint condition is defined as follows:

$$\frac{Min}{r} {‖ Gr ‖}^{2}$$

Here G is an (n−1)×n matrix referred to as the “smooth operator”, and defined by the following:

$$G = [ \begin{matrix}- \frac{1}{\sqrt{2}} & \frac{1}{\sqrt{2}} & & & \\ & - 1.0 & 1.0 & & \\ & & ⋰ & ⋰ & \\ & & - 1.0 & 1.0 & \\ & & & - \frac{1}{\sqrt{2}} & \frac{1}{\sqrt{2}}\end{matrix} ]$$

where r is the unknown reflectance vector defined by equation (4) and ∥y∥ is the 2-norm of the vector y, defined by:

$$‖ y ‖ = \sqrt{{\sum }_{k = 1}^{N} {y}_{k}^{2}}$$

if y is a vector with N components. Since the vector r should satisfy equations (3) and (5), therefore, the smoothness vector r is the solution of the following constrained least squares problem:

$$\frac{Min}{o \leq r \leq e} {‖ Gr ‖}^{2}$$

subject to p=W^{T}r r is always between 0 and 1, i.e., within the defined boundary.

It is assumed that the reflectance vector r generated by the above smoothness approach has a high degree of colour constancy. However, it has been realised by the inventors that the colour constancy of such reflectance vector may be improved as follows.

A procedure for calculating a colour inconstancy index CON of the reflectance vector r is described below.
1. Compute tristimulus values denoted by P_{R}, using the reflectance vector under a reference illuminant.
2. Compute tristimulus values denoted by P_{T}, using the reflectance vector under a test illuminant.
3. Using a reliable chromatic adaptation transform such as CMCCAT97, transfer P_{T} to a corresponding colour denoted by P_{TC} under the reference illuminant.
4. Using a reliable colour difference formula such as CIEDE2000, compute the difference ΔE between P_{R} and P_{TC} under the reference illuminant.
5. Define CON as ΔE.

The chromatic transform CMCCAT97 is described in the following paper: “M R Luo and R W G Hunt, A chromatic adaptation transform and a colour inconstancy Index, Color Res Appn, 1998”. The colour difference formula is described in “M R Luo, G Cui and B Rigg, The development of the CIE 2000 colour difference Formula: CIEDE2000, Color Res Appn, 2001”. The reference and test illuminants are provided by the illumination box 10 and are thus fully characterised, allowing the above calculations to be carried out accurately.

The method may be summarised as follows:

Choose the reference illuminant (say D65) and J test illuminants (A, F11, etc).

Choose the smoothness weighting factor a and the weighting factors βⱼ, j=1,2, . . . , J for CON.

For a given colour vector p and using a known weight matrix W in equation (3), solve the following constrained non-linear problem:

$$\frac{Min}{r} [ a {‖ Gr ‖}^{2} + {\sum }_{j = 1}^{J} {β}_{j} Δ E j ] \qquad Equation 6$$

subject to o≦r≦e, and p=W^{T}r for the reflectance vector r.

If the smoothness weighting factor α is set to 0, then the above method generates the reflectance with the least colour inconstancy. However, the reflectance vector r could be too fluctuated to be realistic. At the other extreme, if the weighting factors βⱼ are all set to be zero, then the above method produces a reflectance vector r with smoothness only. By choosing appropriate weighting factors, α and βⱼ, the above method generates reflectances with smoothness and a high degree of colour constancy.

The weight matrix W should be known from the camera characterisation carried out before the apparatus is used to measure the colours of the object 18.

The above described method for predicting a reflectance function from the digital camera's red, green and blue signals results in a reflectance function which is smooth and colour constant across a number of illuminants.

Using the above method, the apparatus is able to characterise and reproduce a colour of the object 18 very realistically and in such a way that the colour is relatively uniform in appearance under various different illuminants.

In industrial design, it is frequently also desired to simulate products in different colours. For example, a fabric of a particular texture might be available in green and the designer may wish to view an equivalent fabric in red. The apparatus according to the invention allows this to be done as follows.

An image of the existing object 18 is taken using the digital camera 12 and a particular area of uniform colour to be analysed is isolated from the background using known software.

Within the above selected area of colour, the R, G, B values are transformed to standardised X, Y, Z values.

Average colour values \overline{X}, \overline{Y}, \overline{Z} are calculated, these being the mean X, Y, Z values for the whole selected area of colour.

At each pixel, a difference value ΔY is calculated, ΔY being equal to the difference between the Y value at the pixel in question and the average Y value, \overline{Y}, such that: ΔY_{l,m} equals Y_{l,m}−\overline{Y}, where l,m represents a particular pixel.

The computer calculates ΔY values at each pixel within the selected area of colour in the image. Because the colour of the area is uniform, the variations in the measured Y values from the average Y value must represent textural effects. Thus the computer can create a “texture profile” for the area of colour, the profile being substantially independent of the colour of the area.

According to the above method only ΔY values (and not ΔX and ΔZ values) are used. The applicants have found that the perceived lightness of an area within an image has much to do with the green response and that the ΔY values give a very good indication of lightness and therefore of texture.

Once ΔY values are stored for each pixel in the selected area, providing the texture profile, this may be used to simulate a similar texture in a different colour. This is carried out as follows.

Firstly the new colour is measured or theoretical colour values provided. The X, Y, Z values are transformed to x, y, Y, where

$$x = \frac{X}{X + Y + Z} , y = \frac{Y}{X + Y + Z} , z = \frac{Z}{X + Y + Z}$$

and x+y+z=1

The X, Y, Z colour space is not very uniform, including very small areas of blue and very large areas of green. The above transform transfers the colour to x, y, Y space in which the various colours are more uniformly represented.

To retain the chosen colour but to superimpose the texture profile of the previously characterised colour, the x, y values remain the same and the Y value is replaced with a value Y_{l,m}, for a pixel l,m:
Y_{l,m}=Y+tΔY_{l,m}
Alternatively, the X, Y, Z values for each pixel l,m may be transformed to:
X_{l,m}=X+tₓΔX_{l,m}
Y_{l,m}=Y+t_{y}ΔY_{l,m}
Z_{l,m}=Z+t_{z}ΔZ_{l,m}

This takes into account the lightness of the red and blue response as well as the green response.

Thus, the lightness values and thus the texture profile of the previous material have been transferred to the new colour.

The term t varies with Y but there are different functions of t against Y for different materials, with the relationship between t and Y depending upon the coarseness of the material. The appropriate values of t may be calculated empirically.

There is thus provided an apparatus and method for providing accurate and versatile information about colours of objects, for capturing high colour fidelity and repeatable images and for simulating different colours of a product having the same texture. The illumination box 10 allows objects to be viewed in controlled conditions under a variety of accurately characterised lights. This, preferably together with the novel method for predicting reflectance functions, enables colours to be characterised in such a way that they are predictable and realistically characterised under all lights. The apparatus and method also provide additional functions such as the ability to superimpose a texture of one fabric on to a different coloured fabric.

Whilst endeavouring in the foregoing specification to draw attention to those features of the invention believed to be of particular importance it should be understood that the Applicants claim protection in respect of any patentable feature or combination of features hereinbefore referred to and/or shown in the drawings whether or not particular emphasis has been placed thereon.

1-31. (canceled)

32. Apparatus for measuring colours of an object, the apparatus including:
an enclosure for receiving the object;
illumination means for illuminating the object within the enclosure;
a digital camera for capturing an image of the object;
a computer connected to the digital camera, for processing information relating to the image of the object; and
display means for displaying information relating to the image of the object.

33. Apparatus according to claim 32, wherein the enclosure includes means for mounting an object therein such that its position may be altered.

34. Apparatus according to claim 33, wherein the mounting means includes a tiltable table for receiving the object, the tiltable table being controllable by the computer.

35. Apparatus according to claim 32, wherein the illumination means are located within the enclosure, and include diffusing means for providing a diffuse light throughout the enclosure.

36. Apparatus according to claim 32, wherein the illumination means includes a plurality of different light sources for providing respectively different illuminations for the object, one or more of the light sources being adjustable to adjust the level of the illumination or the direction of the illumination, and the light sources being controllable by the computer.

37. Apparatus according to claim 32, wherein the digital camera is mounted on the enclosure and is directed into the enclosure for taking an image of the object within the enclosure.

38. Apparatus according to claim 37, wherein the camera is mounted such that its position relative to the enclosure may be varied, and the location and/or the angle of the digital camera may be varied.

39. Apparatus according to claim 38, wherein the camera may be adjusted by the computer.

40. Apparatus according to claim 32, wherein the display means includes a video display unit including a cathode ray tube (CRT).

41. A method for measuring colours of an object, the method including the steps of:
locating the object in an enclosure;
illuminating the object within the enclosure;
using a digital camera to capture an image of the object within the enclosure;
using a computer to process information relating to the image of the object; and
displaying selected information relating to the image of the object.

42. A method according to claim 41, wherein the step of illuminating the object with a number of respectively different light sources.

43. A method according to claim 41, the method including the step of calibrating the digital camera, to transform its red, green, blue (R, G, B) signals into standard X, Y, Z values, the calibration step includes taking an image of a reference chart under one or more of the light sources and comparing the camera responses for each known colour within the reference chart with the standard X, Y, Z responses for that colour.

44. A method according to claim 42, the method including the following steps:
uniformly sampling the visible range of wavelengths (λ=a to λ=b) by choosing an integer n and specifying that
λᵢ=a+(i−1)Δλ, i=1,2, . . . n, with
$$Δλ = \frac{b - a}{n - 1} ;$$
defining a relationship between camera output and reflectance function, using the following equation: P=W^{T}r,
where P includes known Xₚ, Yₚ, Zₚ values, W is a known weight matrix derived from the product of an illuminant function and the CIE \overline{x}, \overline{y}, \overline{z} colour matching functions, W is the transposition of the matrix Wand r is an unknown n component column vector representing reflectance function defined by:
$$r = [ \begin{matrix}R ( {λ}_{1} ) \\ R ( {λ}_{2} ) \\ ⋮ \\ R ( {λ}_{n} )\end{matrix} ]$$
where R(λ₁) to R(λₙ) are the unknown reflectances of the observed object at each of the n different wavelengths; and
finding a solution for P=W^{T}r which includes a measure of both the smoothness and the colour constancy of the reflectance function, the relative importance of smoothness and of colour constancy being defined by respective weighting factors.

45. A method according to claim 42, the method including the following steps:
uniformly sampling the visible range of wavelengths (λ=a to λ=b) by choosing an integer n and specifying that
λᵢ=a+(i−1)Δλ, i=1,2, . . . n, with
$$Δλ = \frac{b - a}{n - 1} ;$$
defining a relationship between camera output and reflectance function, using the following equation: P=W^{T}r,
where P includes known camera R, G, B values, W is a known weight matrix derived from the product of an illuminant function and the CIE \overline{x}, \overline{y}, \overline{z} colour matching functions, W^{T} is the transposition of the matrix W and r is an unknown n component column vector representing reflectance function defined by:
$$r = [ \begin{matrix}R ( {λ}_{1} ) \\ R ( {λ}_{2} ) \\ ⋮ \\ R ( {λ}_{n} )\end{matrix} ]$$
where R(λ₁) to R(λₙ) are the unknown reflectances of the observed object at each of the n different wavelengths; and
finding a solution for P=W^{T}r which includes a measure of both the smoothness and the colour constancy of the reflectance function, the relative importance of smoothness and of colour constancy being defined by respective weighting factors.

46. A method according to claim 43, wherein the weighting factors are predetermined, being calculated empirically.

47. A method according to claim 42, wherein n is at least 16.

48. A method according to claim 42, wherein the smoothness is defined by determining the following:
$$\frac{Min}{r} {‖ Gr ‖}^{2}$$
where G is an (n−1)×(n) matrix defined by the following:
$$G = [ \begin{matrix}- \frac{1}{\sqrt{2}} & \frac{1}{\sqrt{2}} & & & & & \\ & & - 1.0 & 1.0 & & & \\ & & & ⋰ & ⋰ & & \\ & & & - 1.0 & 1.0 & & \\ & & & & & - \frac{1}{\sqrt{2}} & \frac{1}{\sqrt{2}}\end{matrix} ]$$
where r is an unknown n component column vector representing reflectance function (referred to as the “reflectance vector”) and ∥y∥ is the 2-norm of the vector y, defined by
$$‖ y ‖ = \sqrt{{\sum }_{K = 1}^{N} {y}_{k}^{2}}$$

49. A method according to claim 48, wherein o≦r≦e where o is an n component zero vector and e is an n component column vector where all the elements are unity (equal 1).

50. A method according to claim 42, wherein the colour constancy of the reflectance vector is calculated as follows:
compute tristimulus X, Y, Z values (denoted P_{R}) using the reflectance vector, under a reference illuminant;
compute tristimulus X, Y, Z values (denoted P_{T}) using the reflectance vector, under a test illuminant;
using a chromatic adaptation transform, transfer P_{T} to a corresponding colour denoted by P_{TC} under the reference illuminant;
compute the difference ΔE between P_{TC} and P_{R}; and define the colour inconstancy index (CON) as ΔE.

51. A method according to claim 50, wherein a plurality J of test illuminants is used such that the colour inconstancy index is defined as
$${\sum }_{j = 1}^{J} {β}_{j} Δ {E}_{j}$$
where βⱼ is a weighting factor defining the importance of colour constancy under a particular illuminant j.

52. A method according to claim 42, wherein the method further includes the step of providing an indication of an appearance of texture within a selected area of the object, the method including the steps of:
determining an average colour value for the whole of the selected area; and
determining a difference value at each pixel within the image of the selected area, the difference value representing the difference between the measured colour at that pixel and the average colour value for the selected area.

53. A method according to claim 52, wherein the selected area has a substantially uniform colour.

54. A method according to claim 52, wherein difference value is a value ΔY which represents the difference between the tristimulus value Y at that pixel and the average \overline{Y} for the selected area.

55. A method according to claim 54, wherein the difference value also includes a value ΔX which represents the difference between the tristimulus value X at that pixel and the average \overline{X} for the selected area and/or a value ΔZ which represents the difference between the tristimulus value Z at that pixel and the average \overline{Z} for the selected area.

56. A method according to claim 52, wherein texture of the selected area may be represented by an image comprising the difference values for all the respective pixels within the selected area.

57. A method according to claim 42, the method further including the step of simulating the texture of a selected area of an object, for example in an alternative, selected colour, by:
obtaining X, Y, Z values for the selected colour;
converting these to x, y, Y values, where:
$$x = \frac{X}{X + Y + Z} , y = \frac{Y}{X + Y + Z} , z = \frac{Z}{X + Y + Z}$$
where
x+y+z=1
transforming the Y value for each pixel l,m to Y_{l,m}=Y+tΔY_{l,m},
where t is a function of Y.

58. A method according to claim 57, wherein the x, y, and Y_{l,m} values for each pixel are converted to X_{l,m}, Y_{l,m}, Z_{l,m} values and the X, Y, Z values are then transformed to monitor R, G, B values, for displaying the selected colour with the simulated texture on the display means.

59. A method according to claim 57, wherein the X, Y, Z values for each pixel l,m are be transformed to:
X_{l,m}=X+tₓαX_{l,m}
Y_{l,m}=Y+t_{y}αY_{l,m}
Z_{l,m}=Z+t_{z}αZ_{l,m}
